(19) United States
(12) Patent Application Publication
(10) Pub. No.: US 2026/0002098 A1
(43) Pub. Date: Jan. 1, 2026

(54) CLEANING AGENT, METHOD OF MANUFACTURING THEREOF, METHOD OF PRODUCING CLEANED OBJECT, AND METHOD OF CLEANING OBJECT

(71) Applicant: DENSO CORPORATION, Kariya-city (JP)

(72) Inventor: Yasushi ASANO, Kariya-city (JP)

(21) Appl. No.: 19/251,884

(22) Filed: Jun. 27, 2025

(30) Foreign Application Priority Data
Jun. 28, 2024 (JP) 2024-105358

(51) Int. Cl. C11D 7/12; B08B 3/02; B08B 3/08; B08B 13/00; C11D 7/20; C11D 17/00

(52) U.S. Cl. CPC C11D 7/12; B08B 3/02; B08B 3/08; B08B 13/00; C11D 7/20; C11D 17/0013

(57) ABSTRACT

A cleaning agent according to the present disclosure is sprayed onto a cleaning target. The cleaning agent contains an alkaline aqueous solution of baking soda and glass particles. In cleaning with the cleaning agent, the physical cleaning power of solid cleaning components, containing the glass particles, and the chemical cleaning power through the alkaline aqueous solution of baking soda work simultaneously.

### CROSS-REFERENCE TO RELATED APPLICATION

This application is based on and claims the benefit of priority from earlier Japanese Patent Application No. 2024-105358, filed in Japan on Jun. 28, 2024, the description of which is hereby incorporated by reference.

### BACKGROUND

### 1. Technical Field

The present disclosure relates to a cleaning agent, a method of manufacturing thereof, a method of producing a cleaned object, and a method of cleaning an object.

### 2. Related Art

A blasting method involves spraying a blast medium, composed of predetermined particles, along with a jetting medium, which is a fluid, onto a cleaning target. The use of this blasting method can be applied to clean various objects.

### SUMMARY

The present disclosure primarily provides a cleaning agent and a method of manufacturing thereof.

A first aspect of the present disclosure provides a cleaning agent that is sprayed onto a cleaning target for cleaning the cleaning target. This cleaning agent contains an alkaline aqueous solution and glass particles.

A second aspect of the present disclosure provides a method of manufacturing a cleaning agent that is sprayed onto a cleaning target for cleaning the cleaning target. This manufacturing method includes: preparing baking soda particles with an average particle diameter of 200 μm or more and 400 μm or less, glass particles with an average particle diameter of 200 μm or more and 400 μm or less, and water; and mixing the baking soda particles, glass particles, and water. In the mixing process, a volume ratio of solids before mixing to a total volume which is a sum of a volume of solids before mixing containing the baking soda particles and glass particles and a volume of water, is 10 vol % or more and 30 vol % or less, and a mass ratio of the glass particles in the solids before mixing is greater than 50 mass % and equal to or less than 99 mass %.

### BRIEF DESCRIPTION OF THE DRAWINGS

In the accompanying drawings:

FIG. 1 illustrates a schematic configuration of a cleaning apparatus used to clean a cleaning target in a first embodiment;

FIG. 2 is a table showing an air pressure, a solid volume ratio, cleaning time, and an oscillation frequency of a nozzle when cleaning a cleaning target in the first embodiment;

FIG. 3 is a flowchart showing a manufacturing process of a cleaning agent used to clean a cleaning target in the first embodiment;

FIG. 4 is a table showing a composition of raw materials for a cleaning agent in the first embodiment;

FIG. 5 shows a schematic cross-sectional view of a configuration of a cleaning agent when all of baking soda particles are dissolved in water in the first embodiment;

FIG. 6 shows a schematic cross-sectional view of a configuration of a cleaning agent when some of baking soda particles failed to dissolve in water in the first embodiment;

FIG. 7 is a flowchart showing a recycling process including a process to clean a cleaning target in the first embodiment;

FIG. 8 shows an enlarged view of surfaces of a cleaned object and cleaning target in the first embodiment, as well as a schematic diagram of a method for measuring the lightness of those surfaces;

FIG. 9 shows a captured image of a cleaning target before cleaning, using a center housing of an engine starter as an example in the first embodiment;

FIG. 10 shows a captured image of a cleaned object obtained by cleaning the cleaning target shown in FIG. 9;

FIG. 11 shows experimental results of experiments conducted to obtain a relationship between the cleaning effectiveness in step S205 of FIG. 7 and a solid content ratio of glass in raw materials of a cleaning agent.

FIG. 12 shows an enlarged view of a surface of a cleaning target in the first embodiment, as well as a schematic diagram of a mechanism by which a cleaning agent removes dirt from that surface;

FIG. 13 shows a schematic diagram of a relationship between the kinetic energy of solid cleaning components and a Na concentration in an aqueous solution of baking soda of a cleaning agent, respectively, during cleaning, and a solid content ratio of glass in raw materials of the cleaning agent in the first embodiment;

FIG. 14 shows a relationship between a number of cleaning targets (number of targets cleaned) and the cleaning effectiveness using the lightness as an index value, when a solid content ratio of glass is 90 mass %;

FIG. 15 shows a relationship between a number of cleaning targets (number of targets cleaned) and the cleaning effectiveness using the lightness as an index value, when a solid content ratio of glass is 0 mass %; and

FIG. 16 is a schematic diagram of an example in which a degree of contamination is visually inspected by an inspector.

### DETAILED DESCRIPTION OF THE PREFERRED EMBODIMENTS

A blasting method is described in JP 2000-343435 A (Japanese Unexamined Patent Application Publication No. 2000-343435). The blasting method involves spraying a blast medium, composed of predetermined particles, along with a jetting medium, which is a fluid, onto a cleaning target. The use of this blasting method can be applied to clean various objects.

In recent years, the global environment has received increased protection. Therefore, realizing a circular economy in which products and materials are recycled is desirable. For example, vehicle part recycling involves a cleaning process, which is one of the necessary steps in the recycling process. This cleaning process cleans objects to be recycled, specifically vehicle parts. As a cleaning method, various cleaning methods are assumed to be used, such as the blasting method described in JP 2000-343435 A.

The inventor thoroughly studied a method of cleaning and recycling vehicle parts. Consequently, the following points were identified. When recycling vehicle parts, they often have solid matter firmly adhering to them. Therefore, achieving satisfactory cleaning effects with the various existing cleaning agents was challenging. For example, when an alkaline cleaning solution, a mixture of an alkaline stock solution and water, is used as a cleaning agent, a cleaning target must be cleaned for a long time. Furthermore, cleaning with an alkaline cleaning solution often yields unsatisfactory dirt removal, resulting in unsatisfactory cleaning. In such cases, the cleaning target should be discarded. The disposal of cleaning targets leads to an environmental impact.

In view of the above, it is an object of the present disclosure to provide a cleaning agent capable of powerful cleaning compared to conventional cleaning with an alkaline cleaning solution, a method of manufacturing thereof, a method of producing a cleaned object, and a method of cleaning an object.

To achieve the above object, a first aspect of the present disclosure provides a cleaning agent that is sprayed onto a cleaning target for cleaning the cleaning target. This cleaning agent contains an alkaline aqueous solution and glass particles.

With this configuration, the physical cleaning power of glass particles is used to remove dirt from a surface of a cleaning target by impacting the glass particles on the surface of the cleaning target, while the chemical cleaning power of an alkaline aqueous solution simultaneously removes dirt from the surface of the cleaning target through a chemical reaction. Therefore, compared to conventional cleaning with an alkaline cleaning solution, it is possible to more effectively clean (powerfully clean) a cleaning target.

A second aspect of the present disclosure provides a method of manufacturing a cleaning agent that is sprayed onto a cleaning target for cleaning the cleaning target. This manufacturing method includes: preparing baking soda particles with an average particle diameter of 200 μm or more and 400 μm or less, glass particles with an average particle diameter of 200 μm or more and 400 μm or less, and water; and mixing the baking soda particles, glass particles, and water. In the mixing process, a volume ratio of solids before mixing to a total volume which is a sum of a volume of solids before mixing containing the baking soda particles and glass particles and a volume of water, is 10 vol % or more and 30 vol % or less, and a mass ratio of the glass particles in the solids before mixing is greater than 50 mass % and equal to or less than 99 mass %.

This method enables a cleaning agent that can simultaneously work with both physical and chemical cleaning powers during a cleaning process. Therefore, compared to conventional cleaning with an alkaline cleaning solution, it is possible to more effectively clean (powerfully clean) a cleaning target. Then, for example, the physical cleaning power is enhanced compared to a case where a mass ratio of glass particles is 50 mass % or less. As a result, it is possible to obtain a cleaning agent that can more effectively clean (powerfully clean) a cleaning target.

A third aspect of the present disclosure provides a method of producing a cleaned object in which a cleaning target is cleaned. This production method includes: preparing the cleaning target, preparing a cleaning agent containing an alkaline aqueous solution and glass particles, cleaning the cleaning target by spraying the cleaning agent onto the cleaning target, and obtaining the cleaned object as the cleaning target after cleaning.

With this method, the physical and chemical cleaning powers work simultaneously in cleaning with a cleaning agent. Therefore, compared to conventional cleaning with an alkaline cleaning solution, it is possible to more effectively clean (powerfully clean) a cleaning target. As a result, it is possible to reduce unsatisfactory cleaning of a cleaned object.

A fourth aspect of the present disclosure provides a method of cleaning a cleaning target on which dirt is adhered. This cleaning method includes: preparing a cleaning target, preparing a cleaning agent containing an alkaline aqueous solution and glass particles, and cleaning the cleaning target by spraying the cleaning agent onto the cleaning target, to remove the dirt from the cleaning target.

With this method, the physical and chemical cleaning powers work simultaneously in cleaning with a cleaning agent. Therefore, compared to conventional cleaning with an alkaline cleaning solution, it is possible to more effectively clean (powerfully clean) a cleaning target.

Each element may be marked with the bracketed reference signs in the various paragraphs in this description. In this case, the reference signs indicate one example of the correspondence between the same element and the specific configuration described in the embodiments below. Therefore, this disclosure is not limited by the reference signs.

The following are descriptions of embodiments of the present disclosure, with reference to the drawings as appropriate. The following embodiments and variations thereof, as well as the related drawings, are schematic or simplified to briefly explain contents of the present disclosure. In each of the following embodiments, elements that are identical or equivalent to each other are marked with the same reference signs in the drawings.

### First Embodiment

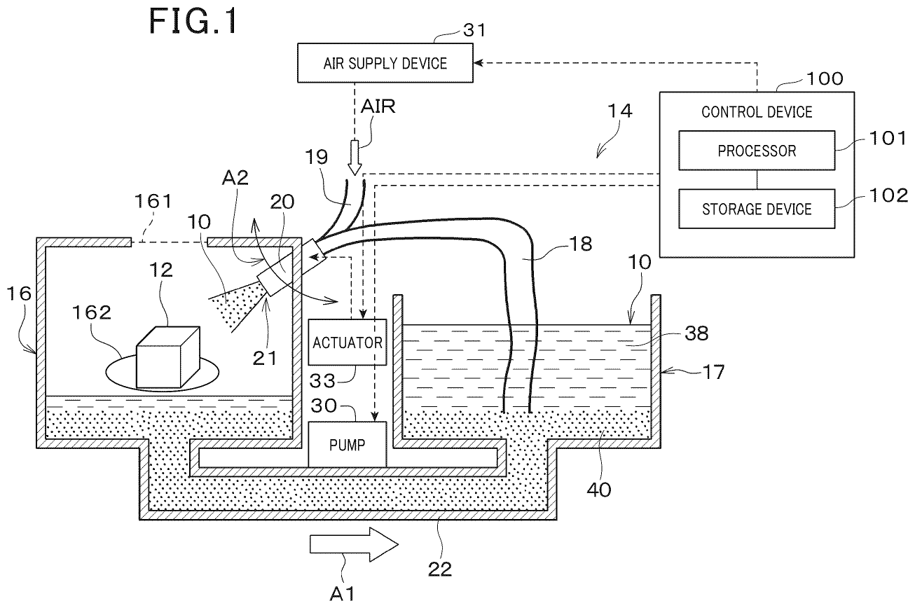

As shown in FIG. 1, a cleaning agent 10 according to the present embodiment is sprayed onto a cleaning target 12 for cleaning the cleaning target 12. The cleaning target 12 refers to an object to be cleaned. The cleaning of cleaning target 12 in the present embodiment is performed as part of a recycling process for vehicle parts. Therefore, the cleaning target 12 may be, for example, metal parts for a vehicle that are removed from a discarded vehicle and recycled. Specifically, the cleaning target 12 is a metal part made of steel or aluminum alloy. Examples of such cleaning targets 12 include a housing of an alternator, which was disposed in an engine compartment or elsewhere, and a center housing of an engine starter. Before cleaning, dirt 12a is firmly adhered to surface 121 (see FIG. 8) of the cleaning target 12. For example, dirt 12a has much oil.

The cleaning agent 10 is used, for example, in the cleaning apparatus 14 shown in FIG. 1, and is sprayed onto the cleaning target 12 in the cleaning apparatus 14. As shown in FIG. 1, the cleaning apparatus 14 is configured to spray the cleaning agent 10 onto the cleaning target 12 housed within this apparatus 14. The cleaning apparatus 14 is configured to include a cleaning tank 16, a cleaning agent tank 17, a cleaning agent supply pipe 18, an air supply pipe 19, a nozzle 20, and a recovery pipe 22.

The cleaning tank 16 is configured to serve as a housing that can contain the cleaning target 12. The cleaning tank 16 is equipped with an opening 161 and the like, allowing the cleaning target 12 to enter and exit through the opening 161. The cleaning tank 16 is configured to surround the cleaning target 12 in a state of containing it during cleaning. This configuration prevents the sprayed cleaning agent 10 from scattering outside of the cleaning tank 16. A mount 162 can be rotated and is provided in the cleaning tank 16. During cleaning, the cleaning target 12 is fixed to the mount 162 and rotates with the mount 162.

The cleaning agent tank 17 is configured to serve as a container for storing the cleaning agent 10. The cleaning agent tank 17 is connected to the cleaning tank 16 via the recovery pipe 22. During cleaning, the cleaning agent 10 is sprayed onto the cleaning target 12 and accumulates in the cleaning tank 16. The accumulated cleaning agent 10 is returned to the cleaning agent tank 17 through the recovery pipe 22, in a direction indicated by an arrow A1, for example, using a pump 30.

The cleaning agent supply pipe 18 is configured to serve as a pipe that supplies the cleaning agent 10 stored in the cleaning agent tank 17 to the nozzle 20. One end (first end) of the cleaning agent supply pipe 18 is open and inserted into the cleaning agent 10 stored in the cleaning agent tank 17. The other end (second end) of the cleaning agent supply pipe 18 is open and connected to the nozzle 20. The cleaning agent supply pipe 18 is made of, for example, a flexible hose.

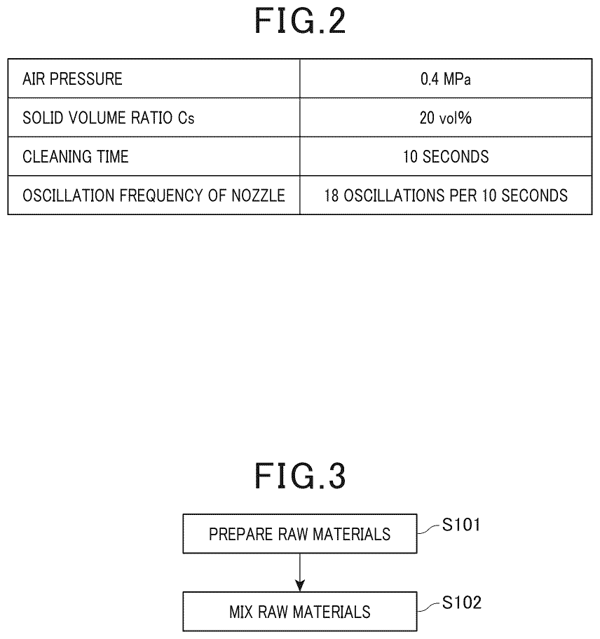

The air supply pipe 19 is configured to serve as a pipe that supplies compressed air AIR from an air supply device 31, such as a plant facility, to the nozzle 20. One end (first end) of the air supply pipe 19 is open and connected to the air supply device 31. The other end (second end) of the air supply pipe 19 is open and connected to the nozzle 20. The air supply pipe 19 is made of, for example, a flexible hose. FIG. 2 is a table showing an air pressure, a solid volume ratio, cleaning time, and an oscillation frequency of the nozzle 20 when cleaning a cleaning target 12 in the present embodiment. In the present embodiment, the compressed air AIR is supplied to the nozzle 20 at an air pressure of approximately 0.4 MPa, as shown in FIG. 2.

The nozzle 20 shown in FIG. 1 is configured to mix the cleaning agent 10 supplied from the cleaning agent supply pipe 18 with the compressed air AIR supplied from the air supply pipe 19. In the cleaning tank 16, the nozzle 20 sprays the cleaning agent 10 and compressed air AIR toward the cleaning target 12 from a jet outlet 21 after mixing. Specifically, the nozzle 20 is supported by the cleaning tank 16 and positioned within the cleaning tank 16. The nozzle 20 is configured to be able to oscillate in a direction indicated by an arrow A2. The nozzle 20 is oscillated, for example, by an actuator 33. Therefore, during cleaning of the cleaning target 12, the nozzle 20 sprays the cleaning agent 10 from the jet outlet 21 onto the cleaning target 12 while oscillating in the direction indicated by the arrow A2.

The air supply device 31, actuator 33, pump 30, and the like, may be electrically connected to a control device 100, for example, as shown in FIG. 1. The control device 100 is configured to include a microcomputer with at least one processor 101 and at least one storage device 102. The control device 100 is connected to the air supply device 31, actuator 33, and pump 30, for example, via a communication medium such as a local area network (LAN). The processor 101 may include, for example, a central processing unit (CPU). The storage device 102 stores programs, data, and the like that the processor can read. The storage device 102 may include, for example, a semiconductor memory, which may include a non-transitory tangible storage medium. The control device 100 is configured to communicate with the air supply device 31, actuator 33, pump 30, and the like. In the control device 100, for example, the processor 101 reads a program stored in the storage device 102 and subsequently executes instructions defined in the program. Accordingly, the control device 100 controls the drive of various devices, such as the air supply device 31, actuator 33, pump 30, and the like. With this configuration, the compressed air AIR is supplied to the air supply pipe 19, resulting in the cleaning agent 10 being sprayed from the nozzle 20. The cleaning agent 10 used in the cleaning is returned from the cleaning tank 16 to the cleaning agent tank 17 through the recovery pipe 22, and is resupplied to the nozzles 20 through the cleaning agent supply pipe 18. The nozzle 20 oscillates during cleaning to clean the entire surface 121 of the cleaning target 12. Thus, the cleaning apparatus 14 is configured to provide a continuous cleaning function by allowing the cleaning agent 10 to circulate between the cleaning tank 16 and the cleaning agent tank 17 while cleaning the cleaning target 12. The above explanation is based on an example of the control device 100 equipped with a microcomputer. For example, the control device 100 may be equipped with electronic circuits, such as an application specific integrated circuit (ASIC) or a field programmable gate array (FPGA) designed to achieve similar functions.

Before cleaning the cleaning target 12, the cleaning agent 10 to be stored in the cleaning apparatus 14 is prepared. FIG. 3 illustrates a method for preparing the cleaning agent 10 before cleaning, in other words, a method for manufacturing the cleaning agent 10.

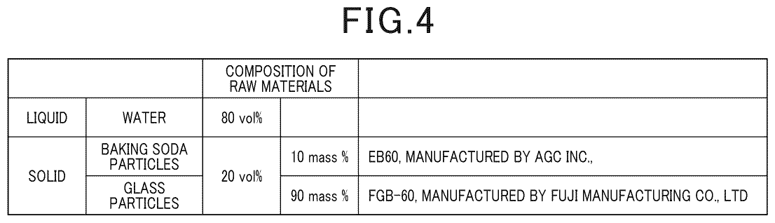

FIG. 3 is a flowchart showing a manufacturing process of the cleaning agent 10 used to clean the cleaning target 12 in the present embodiment. The manufacturing process of the cleaning agent 10 corresponds to each process of the method for manufacturing the cleaning agent 10. FIG. 4 is a table showing a composition of raw materials for the cleaning agent 10 in the present embodiment. As shown in FIG. 3, in step S101, for example, glass particles 41, baking soda particles 42, and water are prepared as the raw materials for the cleaning agent 10 (see FIG. 4). Thus, solids before mixing, which are composed of mixed solids and water, are the glass particles 41 and the baking soda particles 42. The baking soda particles are particles composed of baking soda crystals. An average particle diameter of baking soda particles 42 is within a range of 200 μm or more and 400 μm or less. For example, EB60, manufactured by AGC Inc., may be used as the baking soda particles 42 prepared in step S101. An average particle diameter of EB60 is approximately 300 μm. Baking soda here means sodium hydrogen carbonate (i.e., NaHCO₃).

The glass particles 41 are spherical particles composed of glass. An average particle diameter of the glass particles 41 is within a range of 200 μm or more and 400 μm or less. For example, FGB-60, manufactured by Fuji Manufacturing Co., Ltd may be used as the glass particles 41 prepared in step S101. An average particle diameter of FGB-60 is approximately 300 μm.

In the present embodiment, for example, the average particle diameter of the baking soda particles 42 and the average particle diameter of the glass particles 41 are each calculated as an average value of diameters of particles (i.e., particle diameters) measured for all particles or a predetermined number of sample particles. The preferred number of sample particles is approximately 100 or more, for example. A particle diameter of each of the baking soda particles 42 and the glass particles 41 is measured on a particle-by-particle basis using a microscope. More specifically, the baking soda particles 42 may have a shape with different dimensions in longitudinal and lateral directions, rather than a spherical shape. A longitudinal dimension of the baking soda particles 42 can be regarded as a particle diameter of the baking soda particles 42. Therefore, the particle diameter of the baking soda particles 42 is measured by a microscope as the longitudinal dimension. On the other hand, the glass particles 41 may be spherical particles; therefore, longitudinal and lateral dimensions are the same. In this case, it is not necessary to distinguish between the longitudinal and lateral dimensions of the glass particles 41. Thus, the particle diameter of the glass particles 41 is measured by a microscope as either the longitudinal or lateral dimension.

A solid volume ratio Cs is defined as a volume ratio of solids before mixing to a total volume which is a sum of a volume of solids before mixing with water and a volume of water. In step S101, the solid volume ratio Cs is preferably a value in a range of 10 vol % or more and 30 vol % or less. In the present embodiment, the solid volume ratio Cs may be, for example, 20 vol %, as shown in FIGS. 2 and 4. Thus, in the present embodiment, a volume ratio of water may be, for example, 80 vol % (=100−20). A solid content ratio Rg of glass is defined as a mass ratio of the glass particles in solids before mixing with water. The solid content ratio Rg of glass is preferably a value in a range of greater than 50 mass % and equal to or less than 99 mass %. In the present embodiment, the solid content ratio Rg may be, for example, 90 mass %. Thus, in the present embodiment, a solid content ratio of the baking soda particles 42 may be, for example, 10 mass % (=100−90).

As described above, the solid volume ratio Cs refers to the volume ratio of solids before mixing to the total volume which includes the volume of solids before mixing with water (i.e., each volume of the baking soda particles 42 and glass particles 41) and the volume of water Vw. Therefore, the solid volume fraction Cs is calculated from Equation F1 below based on the volume Vg of the glass particles 41, the volume Vj of the baking soda particles 42, and the volume Vw of water.

Cs=(Vg+Vj)/(Vg+Vj+Vw)×100 (F1)

The solid content ratio Rg of glass refers to the mass ratio of solids before mixing with water, which is accounted for by the glass particles 41. Therefore, the solid content ratio Rg of glass is calculated from Equation F2 below based on a glass particle mass Mg, which is a mass of the glass particles 41, and a baking soda particle mass Mj, which is a mass of the baking soda particles 42. The above solid volume ratio Cs and solid content ratio Rg of glass refer to component ratios before mixing with the baking soda particles 42, glass particles 41, and water, stated otherwise.

Rg=Mg/(Mg+Mj)×100 (F2)

In the method for manufacturing the cleaning agent 10, after the completion of step S101 in FIG. 3, step S102 is performed. In step S102, raw materials of the cleaning agent 10 prepared in step S101, i.e., the baking soda particles 42, glass particles 41, and water, are mixed. Accordingly, in the present embodiment, the cleaning agent 10 is produced. More specifically, all raw materials prepared in step S101 are mixed in step S102. That is, the solid volume ratio Cs of the raw materials mixed in step S102 and the solid content ratio Rg of glass are identical to the values in step S101, respectively.

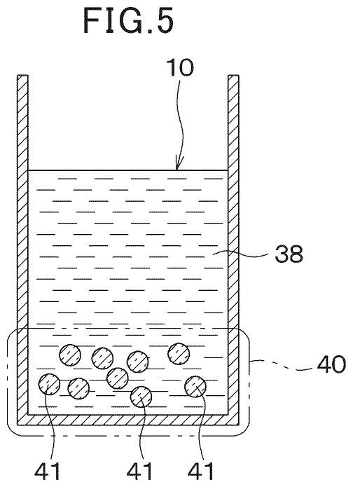

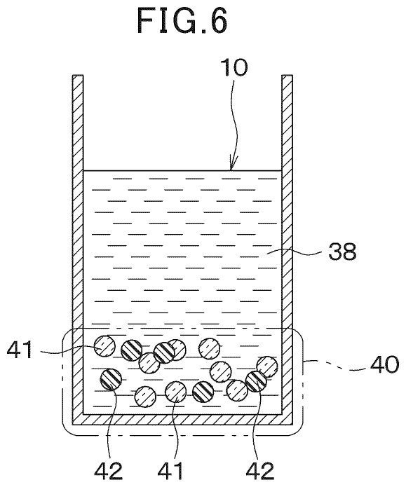

FIG. 5 shows a schematic cross-sectional view of a configuration of the cleaning agent 10 when all of the baking soda particles 42 are dissolved in water in the present embodiment. FIG. 6 shows a schematic cross-sectional view of a configuration of the cleaning agent 10 when some of the baking soda particles 42 failed to dissolve in water in the present embodiment. As a result of mixing the baking soda particles 42 with the glass particles 41 and water, some or all of the baking soda particles 42 dissolve in water. This results in a chemical reaction defined in Equation F3 below. As a result, as shown in FIG. 5 or 6, the cleaning agent 10 contains at least an aqueous solution 38 of baking soda and glass particles 41. For example, when some of the baking soda particles 42 could not dissolve in water, the cleaning agent 10 contains the aqueous solution 38 of baking soda, the glass particles 41, and the baking soda particles 42. As shown in Equation F3 below, the aqueous solution 38 of baking soda obtained in step S102, i.e., obtained by dissolving baking soda in water, refers to an alkaline aqueous solution.

NaHCO₃+H₂O→Na⁺+OH⁻+H₂O+CO₂ (F3)

As described above, in step S102, the baking soda particles 42 dissolve in water. When all of the baking soda particles 42 can be dissolved in water, as shown in FIG. 5, solid cleaning components 40 in the cleaning agent 10 contain solid glass particles 41 and do not contain solid baking soda particles 42. The solid cleaning components 40 in the cleaning agent 10 are a solid component in the cleaning agent 10, in other words, a solid material.

On the other hand, when some of the baking soda particles 42 could not dissolve in water, as shown in FIG. 6, the solid cleaning components 40 in the cleaning agent 10 contain both solid baking soda particles 42 and solid glass particles 41. Before mixing, the mass ratio of baking soda particles 42 is less than the mass ratio of glass particles 41. Therefore, in the solid cleaning components 40 in the cleaning agent 10 after mixing, the mass ratio of baking soda particles 42 is also less than the mass ratio of the glass particles 41.

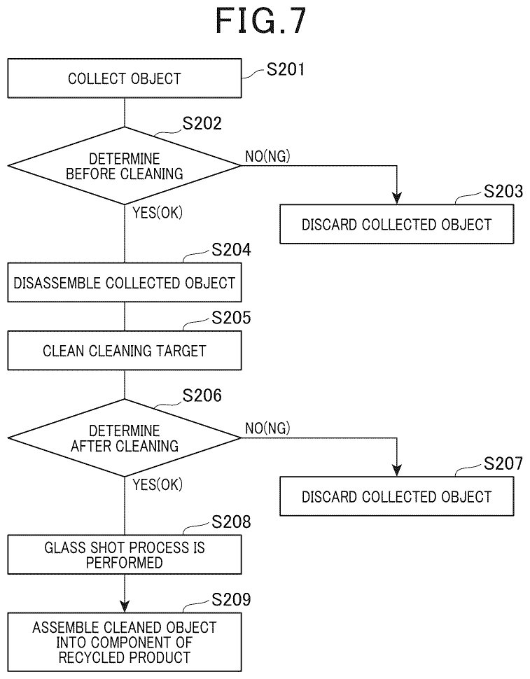

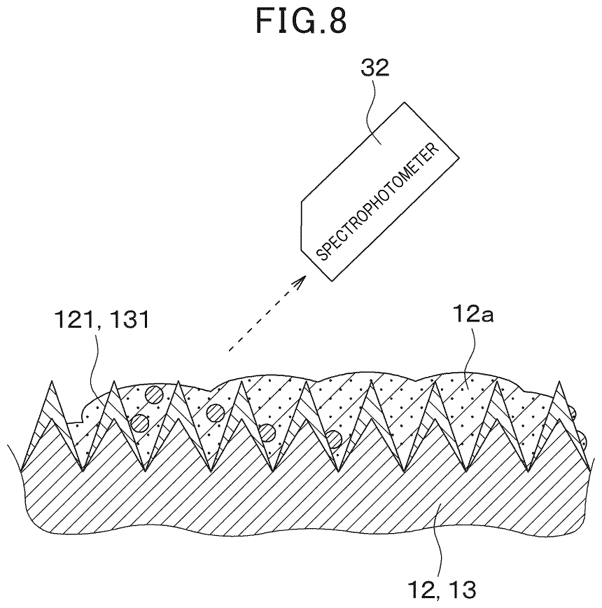

Next, a method for obtaining a cleaned object 13 by cleaning a cleaning target 12 with the cleaning agent 10 described above, in other words, a method for producing the cleaned object 13 that has been cleaned with the cleaning agent 10, is explained using FIG. 7. FIG. 7 is a flowchart showing a recycling process for a cleaned object 13 in the present embodiment. The recycling process shown in FIG. 7 includes a process to clean a cleaning target 12, as well as a process to produce the cleaned object 13. The process to clean the cleaning target 12 corresponds to each step of the method for cleaning the cleaning target 12. The process to produce the cleaned object 13 corresponds to each step of the method for producing the cleaned object 13. As shown in FIG. 7, in step S201, objects before cleaning, including the cleaning target 12, are collected from a market for used parts. The market for used parts is primarily led by vehicle dismantlers and other entities, which act as distribution channels for used vehicle parts. For example, if a vehicle part before cleaning is a used engine starter removed from a discarded vehicle, the cleaning target 12 may be, for example, a center housing of the removed engine starter. If a vehicle part before cleaning is a used alternator removed from a discarded vehicle, the cleaning target 12 may be, for example, a housing of the removed alternator.

In the method for producing the cleaned object 13, after the completion of step S201 in FIG. 7, step S202 is performed. In step S202, it is determined whether it is possible to clean the cleaning target 12 to sufficiently remove the dirt 12a. The cleaning target 12 which is removed from an object before cleaning is cleaned in a cleaning step corresponding to step S205. Therefore, it is determined before cleaning whether the cleaning step corresponding to step S205 can sufficiently remove the dirt 12a from the cleaning target 12. FIG. 8 shows an enlarged view of a surface 131 of the cleaned object 13 and the surface 121 of the cleaning target 12 in the present embodiment, as well as a schematic diagram of a method for measuring the lightness of those surfaces 121 and 131. In the above determination step before cleaning, for example, a lightness measurement is performed to the surface 121 of the cleaning target 12, as shown in FIG. 8. When a measured value of the lightness L* is equal to or greater than a first lightness determination value, it is determined that it is possible for cleaning to sufficiently remove the dirt 12a from the cleaning target 12 (step S202: YES). On the other hand, when the measured value of the lightness L* is less than the first lightness determination value, it is determined that it is impossible for cleaning to sufficiently remove the dirt 12a from the cleaning target 12 (step S202: NO).

The above first lightness determination value is set by conducting experiments in advance so that it can determine whether it is possible to clean the cleaning target 12 according to the performance of cleaning performed in step S205 described below. For example, the first lightness determination value is set as a predetermined threshold for determining cleanability, which is a value of the lightness L* derived based on the results of the lightness measurements and cleaning experiments using multiple samples of the cleaning target 12. The lightness L* is measured using, for example, a spectrophotometer 32, as shown in FIG. 8.

In step S202, when determining that it is possible for cleaning to sufficiently remove dirt 12a from the cleaning target 12, i.e., the measured value of the lightness L* is equal to or greater than the first lightness determination value, step S204 is performed. On the other hand, when determining that it is impossible for cleaning to sufficiently remove dirt 12a from the cleaning target 12, i.e., the measured value of the lightness L* is less than the first lightness determination value, step S203 is performed. In step S203, an object before cleaning, whose the measured value of the lightness L* is less than the first lightness determination value, is discarded. In other words, in step S203, the cleaning target 12 is discarded because it is determined that the cleaning apparatus 14 cannot produce a desired cleaned object 13.

In step S204, an object before cleaning is disassembled and a cleaning target 12 that is determined to be cleanable is removed from the disassembled object. In other words, in step S204, the cleaning target 12 is prepared.

In the method for producing the cleaned object 13, after the completion of step S204, step S205 is performed. In step S205, the cleaning agent 10 is sprayed from the jet outlet 21 of the nozzle 20 toward the surface 121 of the cleaning target 12. Thus, the dirt 12a is removed from the cleaning target 12, effectively cleaning it. Therefore, before cleaning the cleaning target 12, the cleaning agent 10, containing the aqueous solution 38 of baking soda and glass particles 41, is prepared in advance according to the respective steps shown in FIG. 3.

Specifically, in step S205, the cleaning target 12 is fixed on the mount 162 provided in the cleaning tank 16 of the cleaning apparatus 14, as shown in FIG. 1. The cleaning of the cleaning target 12 is then initiated. During cleaning the cleaning target 12, the nozzle 20 of the cleaning apparatus 14 sprays the cleaning agent 10 together with the compressed air AIR onto the cleaning target 12 while being oscillated by the actuator 33 in the direction indicated by the arrow A2. At the same time, the mount 162 rotates while the cleaning target 12 also rotates.

Accordingly, the cleaning agent 10 is sprayed over the entire surface 121 of the cleaning target 12. For example, when the cleaning target 12 is a concave part, such as a housing, the cleaning agent 10 is sprayed over entire inner and outer surfaces of the concave part. Thus, in step S205, the cleaning target 12 is cleaned. As a result, the dirt 12a that adhered to the surface 121 of the cleaning target 12 is removed.

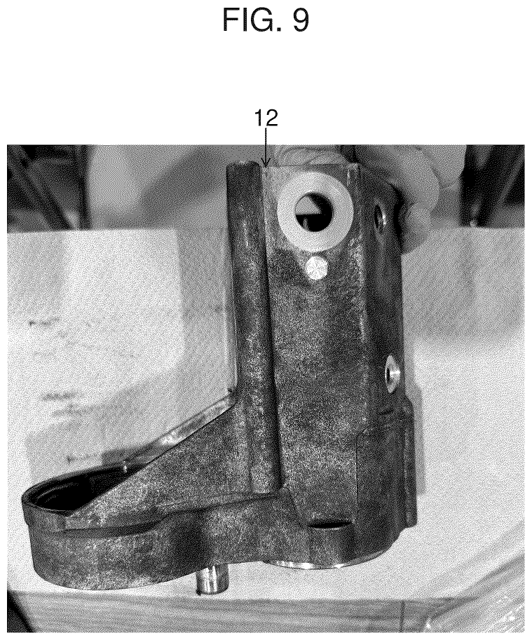

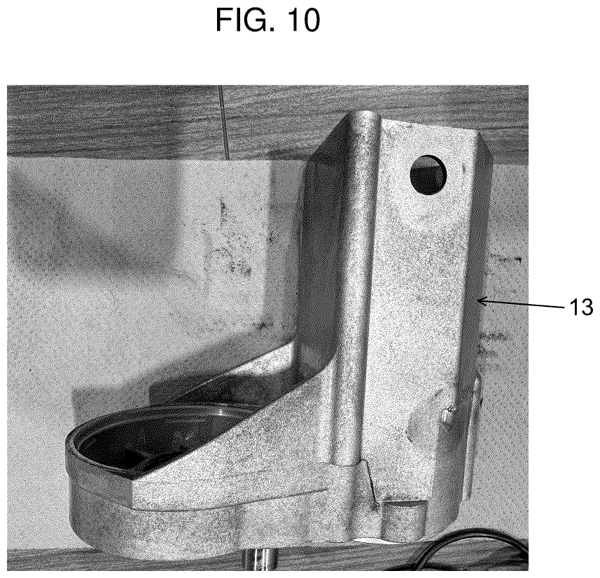

After the completion of cleaning the cleaning target 12, the cleaning target 12 is removed from the mount 162 of the cleaning apparatus 14. As a result, the cleaning target 12 is obtained as the cleaned object 13. FIG. 9 shows a captured image of the cleaning target 12 before cleaning, using a center housing of an engine starter as an example in the present embodiment. FIG. 10 shows a captured image of the cleaned object 13 obtained by cleaning the cleaning target 12 shown in FIG. 9.

For example, in cleaning in step S205 above, the cleaning time is 10 seconds, as shown in FIG. 2. The cleaning time refers to the duration for the cleaning agent 10 to be sprayed onto the cleaning target 12. An oscillation frequency of the nozzle 20 is 18 oscillations per 10 seconds. The oscillation frequency of nozzle 20 refers to the number of times the nozzle 20 oscillates during cleaning. The temperature of the cleaning agent 10 is preferably a value in a range of 10° C. or more and 30° C. or less, more preferably approximately 30° C.

In the method for producing the cleaned object 13, after the completion of step S205, step S206 is performed. In step S206, it is determined whether the dirt 12a has been sufficiently removed after cleaning in the cleaned object 13 obtained in step S205. In other words, step S206 determines whether the cleaned object 13 is recyclable. Specifically, in step S206, the lightness measurement is performed in the same manner as in step S202 above. However, a second lightness determination value obtained after cleaning differs from the first lightness determination value used before cleaning in step S202.

In the above determination step after cleaning, the lightness measurement is performed to the surface 131 of the cleaned object 13, for example, as shown in FIG. 8. When a measured value of the lightness L′ is equal to or greater than the second lightness determination value, it is determined that the dirt 12a has been sufficiently removed in the cleaned object 13 (step S206: YES). On the other hand, when the measured value of the lightness L* is less than the second lightness determination value, it is determined that removing the dirt 12a is insufficient in the cleaned object 13 (step S206: NO).

The above second lightness determination value is set by conducting experiments in advance to determine whether the dirt 12a has been sufficiently removed in the cleaned object 13. In other words, the second lightness determination value is set by conducting experiments in advance so that it can determine whether the dirt 12a has been sufficiently removed by cleaning in step S205. Thus, the second lightness determination value is a metric used to assess whether the cleaning result of step S205 is satisfactory or unsatisfactory (good result or poor result). For example, the second lightness determination value is set as a predetermined threshold for determining that the dirt 12a has been removed, which is a value of the lightness L* derived based on the results of the lightness measurements and cleaning experiments using multiple samples of the cleaned object 13. The measurement of the lightness L* in step S206 is performed in the same manner as in step S202 above, using, for example, a spectrophotometer 32.

In step S206, when it is determined that the dirt 12a has been sufficiently removed in the cleaned object 13, i.e., the measured value of the lightness L* is equal to or greater than the second lightness determination value, step S208 is performed. In this case, the cleaned object 13 is deemed a satisfactory product.

On the other hand, when determining that removing the dirt 12a is insufficient in the cleaned object 13, i.e., the measured value of the lightness L′ is less than the second lightness determination value, step S207 is performed. In this case, the cleaned object 13 is deemed an unsatisfactory product. In step S207, the cleaned object 13, whose the measured value of the lightness L* is less than the second lightness determination value, is discarded. In other words, in step S207, the cleaned object 13 is discarded because the cleaning equipment 14 determined that the cleaned object 13 is an unsatisfactory product.

In step S208, a glass shot process is performed to the cleaned object 13. In the glass shot process, glass particles are sprayed onto the entire surface 131 of the cleaned object 13, along with high-pressure air. Accordingly, the remaining dirt 12a on the surface 131 of the cleaned object 13 is blown and removed. The glass shot process is a surface treatment process in which micro glass particles are sprayed to achieve a specified surface treatment. For example, glass particles used in the glass shot process may be the same as the glass particles 41 in the cleaning agent 10, or they may be different from the glass particles 41 in the cleaning agent 10.

In the method for producing the cleaned object 13, after the completion of step S208 in FIG. 7, step S209 is performed. In step S209, the cleaned object 13, whose surface 131 has been treated through the glass shot process, is assembled into a component of a recycled product, and a recycled product is then produced with the cleaned object 13. As a result, a recycled product with the cleaned object 13 is produced. For example, if the cleaned object 13 is a center housing of an engine starter, the recycled product is the engine starter. If the cleaned object 13 is a housing of an alternator, the recycled product is the alternator.

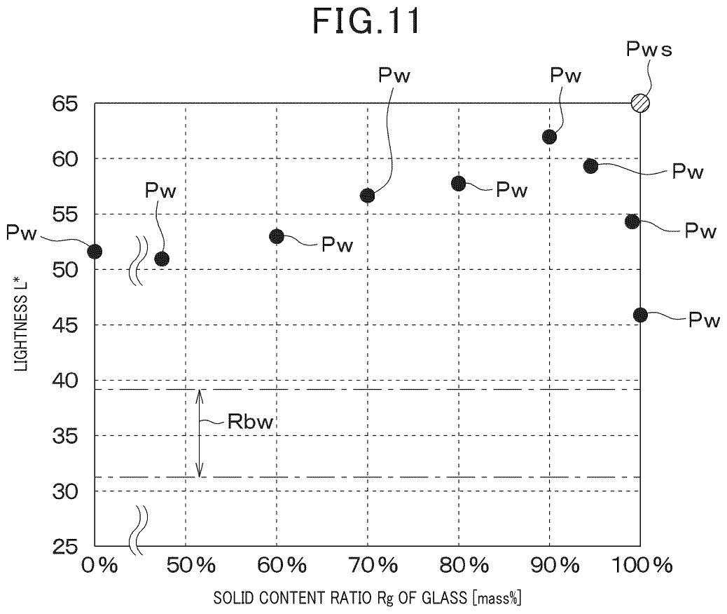

In step S101, the solid content ratio Rg of glass may be set to 90 mass %, for example. FIG. 11 shows experimental results of experiments conducted to obtain a relationship between the cleaning effectiveness in step S205 of FIG. 7 and the solid content ratio Rg of glass in the raw materials of the cleaning agent 10. In the experiments shown in FIG. 11, the cleaning target 12 is a center housing of an engine starter. The cleaning agent 10 is manufactured according to the process shown in FIG. 3, except the solid content ratio Rg of glass is changed. Thus, the solid volume ratio Cs of the raw materials before mixing the cleaning agent 10 may be, for example, 20 vol %, as described above in FIG. 4. The experiments shown in FIG. 11 are designed to verify the cleaning effectiveness in step S205 of FIG. 7. Therefore, in the experiments in FIG. 11, no glass shot process is performed after cleaning.

A vertical axis of FIG. 11 represents the lightness L*, while a horizontal axis represents the solid content ratio Rg of glass. The lightness L′ is an index value indicating cleaning effectiveness. A higher lightness L* indicates less dirt 12a after cleaning. Multiple relational points Pw shown in FIG. 11 result from plotting the experimental data. These plotted multiple relational points Pw illustrate the relationship between the lightness L′ measured for the surface 131 of the cleaned object 13 and the solid content ratio Rg of glass. The lightness L* represented by each of the multiple relational points Pw reflects an average value of lightness L* measurements taken from various locations on the surface 131 of the cleaned object 13. In the experiments in FIG. 11, values of the lightness L* measurements for the cleaning target 12 before cleaning are all within a range Rbw of the lightness L* before cleaning, as shown in FIG. 11.

When the cleaning agent 10 is manufactured according to the process shown in FIG. 3, the experimental results found the following points, represented by the multiple relational points Pw in FIG. 11. The cleaning power of the cleaning agent 10 is strongest when the solid content ratio Rg of glass is approximately Rg=90 mass %. Therefore, according to the experimental results shown in FIG. 11, the solid content ratio Rg of glass is preferably a value in a range of greater than 50 mass % and equal to or less than 99 mass %, and more preferably a value in a range of 85 mass % or more and 95 mass % or less, to achieve high cleaning power of the cleaning agent 10.

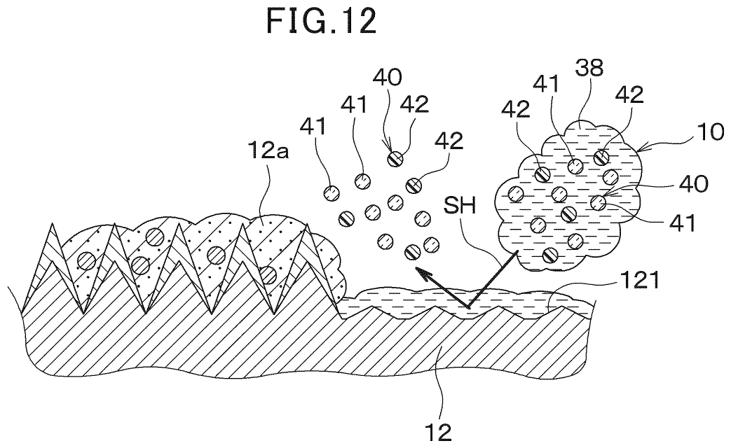

FIG. 12 shows an enlarged view of the surface 121 of the cleaning target 12 in the present embodiment, as well as a schematic diagram of a mechanism by which the cleaning agent 10 removes the dirt 12a from that surface 121. As shown in FIG. 12, the reason for the experimental results shown in FIG. 11 is that the synergistic effect of the physical and chemical cleaning powers of the cleaning agent 10 effectively removes the dirt 12a from the surface 121 of the cleaning target 12 in the cleaning process using the cleaning agent 10. The physical cleaning power refers to the cleaning power of the solid cleaning components 40 in the cleaning agent 10 to remove the dirt 12a by impacting the solid cleaning components 40 on the surface 121 of the cleaning target 12, as indicated by an arrow SH. The chemical cleaning power refers to the cleaning power of the aqueous solution 38 of baking soda to remove the dirt 12a from the surface 121 of the cleaning target 12 through a chemical reaction of an alkaline aqueous solution.

The physical cleaning power of the cleaning agent 10 is described in detail below. The greater the kinetic energy of all solid cleaning components 40 of the cleaning target 10, the higher the physical cleaning power applied to the cleaning target 10. The total kinetic energy of all solid cleaning components 40 is a sum of the kinetic energy Es of each particle 41 and 42, calculated from Equations F4 and F5 below.

Es=m×v²/2 (F4)

m=(4/3)λπ×r³×ρ (F5)

In Equations F4 and F5 above, m refers to the mass of particles containing the solid cleaning components 40. v refers to a velocity of a particle. r refers to a radius of a particle, i.e., ½ of an average particle diameter. ρ refers to density of particles that contain the solid cleaning components 40. The density of the glass particles 41 corresponds to ρ=2.5 g/cm³. The density of the baking soda particles 42 corresponds to ρ=2.2 g/cm³. When some of the baking soda particles 42 could not dissolve in water, the average particle diameter of the baking soda particles 42 that could not dissolve is assumed to be substantially the same as the average particle diameter of the baking soda particles 42 before mixing, as prepared in step S101 of FIG. 3.

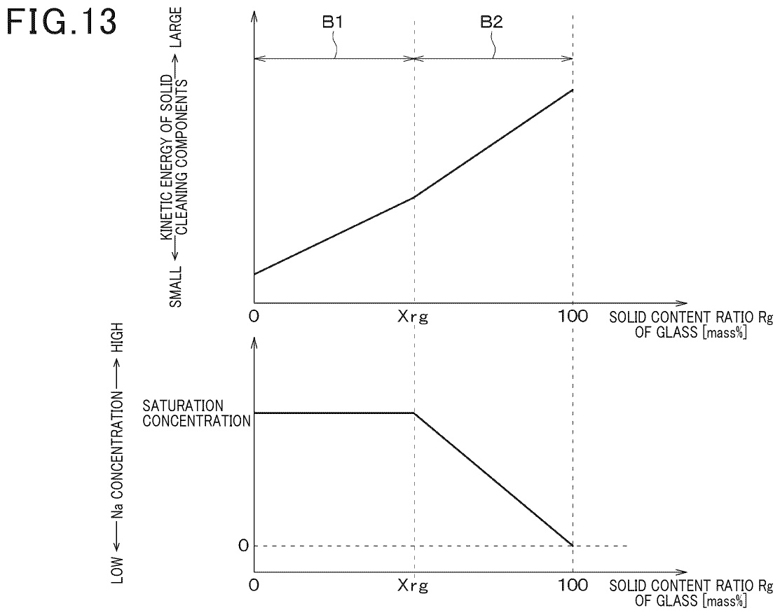

FIG. 13 shows a schematic diagram of a relationship between the kinetic energy of solid cleaning components 40 and a Na concentration in the aqueous solution 38 of baking soda of the cleaning agent 10, respectively, during cleaning, and a solid content ratio Rg of glass in raw materials of the cleaning agent 10 in the present embodiment. The glass particles 41 and the baking soda particles 42 impact the dirt 12a on the surface 121 of the cleaning target 12 while being contained in the aqueous solution 38 of baking soda. Therefore, the velocity v, when impacting, is considered no different for any of the glass particles 41 and the baking soda particles 42. Further, as described above, the density of the glass particles 41 is greater than that of the baking soda particles 42. Therefore, as seen from Equations F4 and F5 above, the greater the number of the glass particles 41 in the solid cleaning components 40, the greater the kinetic energy of the solid cleaning components 40 during cleaning becomes. Furthermore, the higher the solid content ratio Rg of glass in step S101 of FIG. 3, the greater the number of the glass particles 41 in the solid cleaning components 40 becomes. Therefore, as shown in FIG. 13, the higher the solid content ratio Rg of glass, the greater the kinetic energy of the solid cleaning components 40 becomes. In other words, the higher the solid content ratio Rg of glass, the higher the physical cleaning power of the cleaning target 10 becomes

The chemical cleaning power of the cleaning agent 10 is described in detail below. Sodium ions (i.e., Na⁺) are present in the aqueous solution 38 of baking soda in the cleaning agent 10, as shown in Equation F3 above. The sodium ions remove the dirt 12a from the surface 121 of the cleaning target 12 through the chemical reaction shown in Equation F6 below. R in Equation F6 below stands for an alkyl group. RCOOH on the left side corresponds to the oil content in the dirt 12a.

Na⁺+RCOOH→RCOONa (F6)

As seen from Equation F6 above, the Na concentration, which is the concentration of the sodium ions in the aqueous solution 38 of baking soda, is an index value for the chemical cleaning power of the cleaning agent 10. The higher the Na concentration, the higher the chemical cleaning power of the cleaning agent 10 becomes. The Na concentration of the aqueous solution 38 of baking soda is saturated when an amount of the baking soda particles 42 mixed with water is sufficient to be saturated the solution with respect to sodium ions. The Na concentration then becomes lower, the less baking soda particles 42 are present, when the amount of the baking soda particles 42 is insufficient to be saturated the solution with respect to the sodium ions.

Therefore, as shown in FIG. 13, in a low ratio region B1, where the solid content ratio Rg of glass is below a boundary value Xrg, the Na concentration reaches saturation concentration and remains constant. In a high ratio region B2, where the solid content ratio Rg of glass exceeds the boundary value Xrg, the higher the solid content ratio Rg of glass, the lower the Na concentration becomes. Further, when the solid content ratio Rg of glass is 100 mass %, the baking soda particles 42 as raw materials are not mixed. Therefore, the Na concentration becomes zero. In the experiments shown in FIG. 11, the boundary value Xrg in FIG. 13 is approximately 50 mass %.

Thus, the experimental results represented by the multiple relational points Pw shown in FIG. 11 can be attributed to the synergistic effect of the physical and chemical cleaning powers of the cleaning agent 10, as described above.

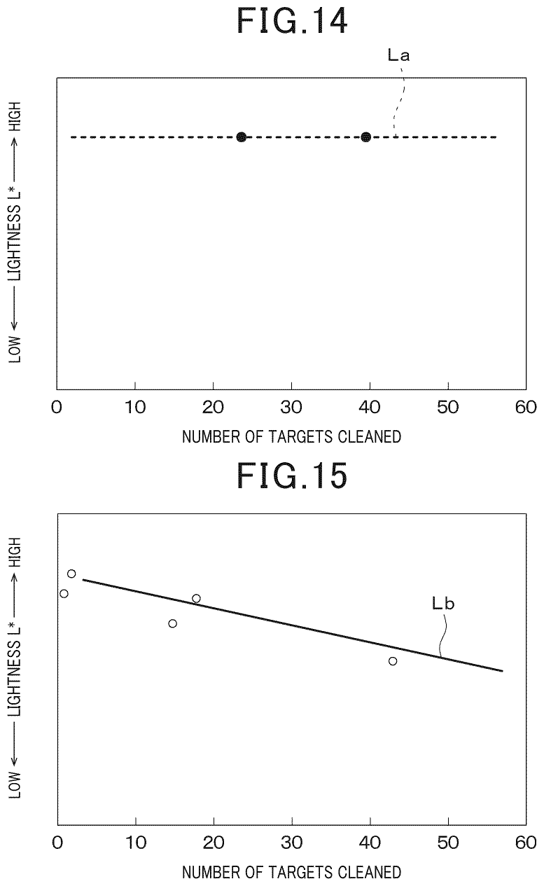

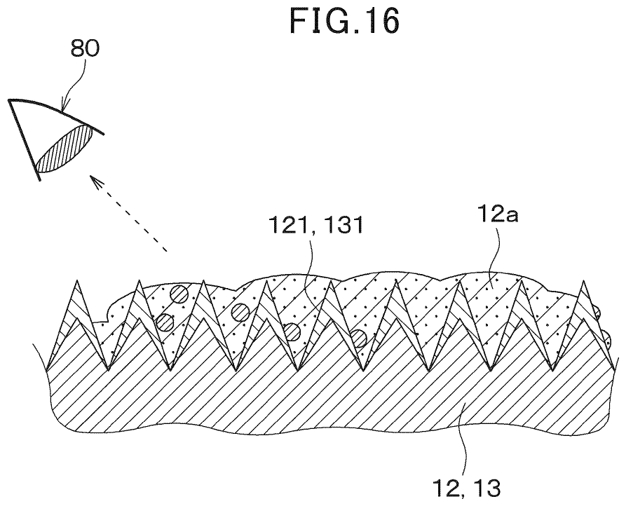

The other experimental results, which differ from the one shown in FIG. 11, are presented in FIGS. 14 and 15. FIG. 14 shows a relationship between a number of cleaning targets 12 (number of targets cleaned) and the cleaning effectiveness using the lightness L* as an index value, when the solid content ratio Rg of glass is 90 mass %. FIG. 15 shows a relationship between a number of cleaning targets 12 (number of targets cleaned) and the cleaning effectiveness using the lightness L* as an index value, when the solid content ratio Rg of glass is 0 mass %. A vertical axis in each of FIGS. 14 and 15 represents the lightness L*. In FIGS. 14 and 15, similar to FIG. 11, the lightness L* serves as the index value for indicating cleaning effectiveness, and the vertical axis scale is consistent between FIGS. 14 and 15.

A horizontal axis in each of FIGS. 14 and 15 represents the number of the cleaning targets 12. The vertical axis represents the lightness L* measured for the surface 131 of the cleaned object 13, which is produced from the latest cleaning target 12 that was cleaned, among the multiple cleaned objects 13. The lightness L* represented in each of FIGS. 14 and 15 is also an average value of lightness L* measurements taken from various locations, as in FIG. 11. A dashed line La shown in FIG. 14 represents the relationship between the number of the cleaning targets 12 and the lightness L* when the solid content ratio Rg of glass is 90 mass %. A solid line Lb shown in FIG. 15 represents the relationship between the number of cleaning targets 12 and the lightness L* when the solid content ratio Rg of glass is 0 mass %.

According to the experimental results shown in FIG. 14, when the solid content ratio Rg of glass is 90 mass %, no micronization of the glass particles 41 and the baking soda particles 42 was observed, regardless of the number of the cleaning targets 12 (number of targets cleaned). The lightness L* measurements were constant regardless of the number of the cleaning targets 12. In contrast, according to the experimental results shown in FIG. 15, when the solid content ratio Rg of glass was 0 mass %, the baking soda particles 42 became micronized when the number of the cleaning targets 12 was slightly over 40. The measured lightness L* decreased with the increasing number of cleaning targets 12. This phenomenon is likely due to the reduced physical cleaning power of the cleaning agent 10 as the baking soda particles 42 become micronized.

According to the experimental results in FIGS. 14 and 15 above, mixing the glass particles 41 into the cleaning agent 10 is effective for enabling the continuous use of the cleaning agent 10. In the experiments shown in FIGS. 14 and 15, similar to those in FIG. 11 above, no glass shot process is performed after cleaning.

As described above, according to the present embodiment, the cleaning agent 10 is sprayed onto the cleaning target 12, as shown in FIGS. 1 and 12. The cleaning agent 10 contains the aqueous solution 38 of baking soda and the glass particles 41. Thus, the cleaning agent 10 is configured to work simultaneously with the physical cleaning power of the solid cleaning components 40, containing the glass particles 41 and the chemical cleaning power of the aqueous solution 38 of baking soda, during the cleaning process.

For example, suppose there is a cleaning method that combines chemical cleaning by spraying an aqueous solution of baking soda onto a cleaning target, followed by physical cleaning using a mixed fluid of water and glass particles sprayed onto the cleaning target alternately. Compared to this cleaning method, the cleaning method of the present embodiment works simultaneously with the physical and chemical cleaning powers, thus achieving high cleaning power. Compared to conventional cleaning with an alkaline cleaning solution, for example, the cleaning target 12 can be more effectively cleaned (powerfully cleaned). The conventional spray cleaning with an alkaline cleaning solution may be, for example, a cleaning method in which an alkaline cleaning solution (an alkaline aqueous solution) at approximately 60° C. with no solids is sprayed onto a cleaning target. In the following explanation, spray cleaning with an alkaline cleaning solution is referred to as alkaline spray cleaning for convenience.

In addition, the conventional alkaline spray cleaning process requires approximately 45 minutes of cleaning time. In contrast, cleaning time for the cleaning method of the present embodiment is 10 seconds, as described above. In other words, the cleaning method of the present embodiment not only has high cleaning power but also reduces the cleaning time compared to the conventional alkaline spray cleaning.

In the cleaning method of the present embodiment, the number of the cleaning targets 12 that were discarded in step S203 in the process shown in FIG. 7, was almost zero. In the cleaning method of the present embodiment, the number of the cleaned objects 13 that were discarded in step S207 in the process shown in FIG. 7, was almost zero. In contrast, in the conventional alkaline spray cleaning process, a ratio of cleaning targets or cleaned objects that were discarded in processes corresponding to steps S203 and S207, i.e., an unsatisfactory rate, was about 60%. In the cleaned object 13 cleaned in step S205 of FIG. 7 in the cleaning method of the present embodiment, it was found that surface 131 was cleaned and the dirt 12a was removed without needing to perform the surface treatment process with glass shot in the subsequent step S208.

These facts indicate that the cleaning method of the present embodiment provides higher cleaning power than the conventional alkaline spray cleaning. Further, in the method for cleaning the cleaning target 12 or the method for producing the cleaned object 13, it may omit any or all of the following processes: the determination of whether the cleaning target 12 is cleanable before cleaning in step S202; the determination of whether the cleaned object 13 is satisfactory or unsatisfactory after cleaning in step S206; and the surface treatment process with glass shot in step S208.

(1) According to the cleaning agent 10 in the present embodiment, an aqueous solution contained in the cleaning agent 10 is the aqueous solution 38 of baking soda. Further, as shown in FIGS. 5 and 6, the solid cleaning components 40 in the cleaning agent 10 are composed of the glass particles 41 and the baking soda particles 42, which have a smaller mass ratio than the glass particles 41. Alternatively, the solid cleaning components 40 in the cleaning agent 10 do not contain the baking soda particles 42 and are composed of the glass particles 41. In summary, the mass ratio of the glass particles 41 in the solid cleaning components 40 exceeds 50 mass %.

Therefore, the cleaning agent 10, according to the present embodiment, can obtain the chemical cleaning power from the aqueous solution 38 of baking soda and enhance the physical cleaning power by containing more glass particles 41, whose density of particles is greater than that of the baking soda particles 42. Consequently, the cleaning power of cleaning agent 10 can be enhanced through the synergistic effect of its chemical and physical cleaning properties.

(2) According to the method for cleaning the cleaning target 12 in the present embodiment, the cleaning target 12 may be, for example, metal parts for a vehicle to be recycled. The metal parts for the vehicle are firmly adhered to dirt 12a, which has much oil. Therefore, the cleaning method in the present embodiment can achieve high cleaning effectiveness for parts that are difficult to clean with the cleaning agent 10, containing the aqueous solution 38 of baking soda and the glass particles 41.

(3) According to the method for manufacturing the cleaning agent 10 in the present embodiment, the glass particles 41, baking soda particles 42, and water are prepared at step S101 of FIG. 3. The average particle diameter of the prepared glass particles 41 is within a range of 200 μm or more and 400 μm or less, and the average particle diameter of the prepared baking soda particles 42 is also within a range of 200 μm or more and 400 μm or less. In step S101, the solid volume ratio Cs is set to a value in a range of 10 vol % or more and 30 vol % or less, and the solid content ratio Rg of glass is set to a value in a range of greater than 50 mass % and equal to or less than 99 mass %. The glass particles 41, baking soda particles 42, and water are mixed in step S102 of FIG. 3. Therefore, as shown in the experimental results in FIG. 11, the synergistic effect of the chemical cleaning power of the aqueous solution 38 of baking soda and the physical cleaning power of the solid cleaning components 40 allows the cleaning agent 10 to exert high cleaning power on the cleaning target 12.

(4) According to the method for manufacturing the cleaning agent 10 in the present embodiment, the solid content ratio Rg of glass in the raw materials prepared in step S101 of FIG. 3 may be, for example, 90 mass %. In other words, in the process shown in FIG. 3, the glass particles 41, baking soda particles 42, and water are mixed with the solid content ratio Rg of glass of 85 mass % or more and 95 mass % or less. Therefore, the cleaning power of the cleaning agent 10 can be maximized, as shown in the experimental results indicated in FIG. 11.

(5) According to the method for producing the cleaned object 13, in step S206 of FIG. 7, the lightness L* of the surface 131 of the cleaned object 13 is measured. When the measured value of lightness L* is equal to or greater than the second lightness determination value, the cleaned object 13 is determined to be a satisfactory product. The second lightness determination value serves as a threshold for evaluating the quality of the cleaned object 13.

Here, we will explain the conventional method for determining a degree of contamination (hereinafter referred to as dirtiness). In any of the dirtiness determinations in the cleaning method of cleaning targets and the production method of cleaned objects, those are visually inspected by an inspector 80, as shown in FIG. 16. In contrast, in the method for cleaning the cleaning targets 12 and the method for producing the cleaned objects 13 in the present embodiment, the dirtiness is determined, for example, by measuring the lightness L* using a spectrophotometer 32. Therefore, it is possible to reduce the variation in the determination results caused by a visual inspection by a person.

### Second Embodiment

The second embodiment is described below. This embodiment mainly explains the differences from the first embodiment. In the description, the same or similar contents as the first embodiment will be omitted or simplified.

In the present embodiment, a method for manufacturing a cleaning agent 10 differs from that in the first embodiment (see FIG. 3). Specifically, in step S101 of FIG. 3, glass particles 41 and an aqueous solution 38 of baking soda are prepared as raw materials for the cleaning agent 10. However, the aqueous solution 38 of baking soda to be prepared is one in which baking soda is dissolved until saturated, i.e., a saturated solution of baking soda. In the method for manufacturing the cleaning agent 10, according to the present embodiment, baking soda particles 42 are not prepared. Therefore, a solid content ratio Rg of glass becomes 100 mass %.

In the present embodiment, an average particle diameter of the glass particles 41 and a solid volume ratio Cs are the same as in the first embodiment, respectively. A saturated aqueous solution of baking soda in the present embodiment is not limited to an aqueous solution where a Na concentration perfectly matches the saturated concentration. For example, it may contain aqueous solutions where the Na concentration is below the saturated concentration; however, for practical purposes, the Na concentration is as high as the saturated concentration.

In step S102 of FIG. 3, the glass particles 41 prepared in step S101 are mixed with the aqueous solution 38 of baking soda. Accordingly, in the present embodiment, the cleaning agent 10 is produced. The aqueous solution 38 of baking soda in the cleaning agent 10 manufactured in this method is a saturated aqueous solution of baking soda prepared in step S101. Therefore, solid cleaning components 40 in the present embodiment do not contain the baking soda particles 42 and are composed of the glass particles 41. Glass particles 41 are insoluble in water. Therefore, a volume ratio of the glass particles 41 in the cleaning agent 10 is the same as the above solid volume ratio Cs in the raw material. Note that the recycling process shown in FIG. 7 is the same in the present embodiment as in the first embodiment.

According to the cleaning agent 10, the aqueous solution 38 of baking soda contained in the cleaning agent 10 is a saturated aqueous solution of baking soda. The solid cleaning components 40 in the cleaning agent 10 do not contain the baking soda particles 42 and are composed of the glass particles 41. Therefore, in the present embodiment of the cleaning agent 10, the chemical cleaning power of the aqueous solution 38 of baking soda can be maximized by using a saturated aqueous solution of baking soda as the aqueous solution 38. Furthermore, the cleaning agent 10 in the present embodiment can contain additional glass particles 41, which have a greater particle density than the baking soda particles 42, compared to the composition of the first embodiment, thereby maximizing the solid content ratio Rg of glass. Therefore, according to the present embodiment of the cleaning agent 10, it is likely to obtain the chemical cleaning power from the saturated aqueous solution of baking soda and to enhance the physical cleaning power through the solid cleaning components 40. Consequently, the cleaning power of cleaning agent 10 can be enhanced through the synergistic effect of its chemical and physical cleaning properties.

For example, in the cleaning in step S205 of FIG. 7, the experimental results are represented by a relational point Pws shown in FIG. 11. According to the experimental results, the measured lightness L* indicated by the relational point Pws in the present embodiment is higher than any measured lightness L* indicated by the multiple relational points Pw, obtained by varying the solid content ratio Rg of glass in the first embodiment. Therefore, it is thought to be preferable to compose the cleaning agent 10 using a saturated aqueous solution of baking soda combined with the glass particles 41, as in the present embodiment, to achieve high cleaning effectiveness.

Except for the above explanation, the present embodiment is the same as the first embodiment. In this embodiment, the effects achievable through the configuration shared with the first embodiment can be attained similarly to those of the first embodiment.

### (Modifications)

(1) In each of the above-described embodiments, steps S202, S206, and S208 are not required in the recycling process shown in FIG. 7. Any or all of those steps may be omitted. If step S202 is omitted, then step S203 may also be omitted. Likewise, if step S206 is omitted, then step S207 may also be omitted.

(2) In the second embodiment described above, the cleaning agent 10 produced in step S102 of FIG. 3 contains the glass particles 41 and does not contain the baking soda particles 42, as the solid cleaning components 40. This configuration is an example of the configuration of the cleaning agent 10 in the present disclosure. For example, the cleaning agent 10 in the second embodiment, the solid cleaning components 40 may also contain some baking soda particles 42 in addition to the glass particles 41. In other words, the solid cleaning components 40 in the second embodiment may be composed of the glass particles 41 and the solid baking soda particles 42, which have a smaller mass ratio than the glass particles 41.

(3) In the second embodiment described above, the aqueous solution 38 of baking soda contained in the cleaning agent 10 is a saturated aqueous solution of baking soda, and a Na concentration of the aqueous solution 38 of baking soda is a saturated concentration. This configuration is an example of the configuration of the cleaning agent 10 in the present disclosure. For example, the aqueous solution 38 of baking soda in the cleaning target 10 in the second embodiment may be an aqueous solution with the Na concentration that is slightly lower than the saturated concentration. More specifically, for example, the aqueous solution 38 of baking soda may be an aqueous solution with a Na concentration of 90% or more and 99% or less of the saturated concentration.

(4) In each of the above embodiments, an alkaline aqueous solution contained in the cleaning agent 10 is the aqueous solution 38 of baking soda obtained by dissolving baking soda in water. This configuration is an example of the configuration of the cleaning agent 10 of the present disclosure. For example, in each embodiment of the cleaning agent 10, the alkaline aqueous solution may be an aqueous solution obtained by dissolving materials other than baking soda in water.

(5) The present disclosure is not limited to the embodiments described above but can be performed with various modifications. Each element of the above embodiments is not necessarily essential as the element, except when expressly stated as particularly essential or when they are critical in principle, etc.

When numerical values of the number, amount, range, etc., of the elements are described, the present disclosure is not limited to those values, except when expressly stated as particularly essential or when limited to a particular value in principle. Similarly, when the shape, orientation, positional relationship, etc., of the elements, etc., are described, the present disclosure is not limited to such shape, orientation, positional relationship, etc., except when expressly stated as particularly essential or when limited to a particular shape, orientation, positional relationship, etc., in principle. The modifications are also not limited to the above description. For example, multiple embodiments, other than those described above, can be combined with each other as long as there is no technical contradiction therebetween. Similarly, multiple modifications can be combined with each other as long as there is no technical contradiction therebetween.

What is claimed is:

1. A cleaning agent that is sprayed onto a cleaning target for cleaning the cleaning target, comprising:
an alkaline aqueous solution; and
glass particles.

2. The cleaning agent according to claim 1, wherein,
the alkaline aqueous solution is an aqueous solution of baking soda,
solid components in the cleaning agent:
contain the glass particles and baking soda particles with a smaller mass ratio than the glass particles, or
contain the glass particles and do not contain the baking soda particles.

3. The cleaning agent according to claim 1, wherein,
the alkaline aqueous solution is a saturated aqueous solution of baking soda,
solid components in the cleaning agent:
contain the glass particles and baking soda particles with a smaller mass ratio than the glass particles, or
contain the glass particles and do not contain the baking soda particles.

4. The cleaning agent according to claim 1, wherein,
the cleaning target is a metal part for a vehicle.

5. A method of manufacturing a cleaning agent that is sprayed onto a cleaning target for cleaning the cleaning target, comprising:
preparing baking soda particles with an average particle diameter of 200 μm or more and 400 μm or less, glass particles with an average particle diameter of 200 μm or more and 400 μm or less, and water; and
mixing the baking soda particles, the glass particles, and the water, wherein,
in the mixing, a volume ratio of solids before mixing to a total volume which is a sum of a volume of solids before mixing containing the baking soda particles and the glass particles and a volume of the water, is 10 vol % or more and 30 vol % or less, and a mass ratio of the glass particles in the solids before mixing is greater than 50 mass % and equal to or less than 99 mass %.

6. The method of manufacturing the cleaning agent according to claim 5, wherein,
in the mixing, the baking soda particles, the glass particles with the mass ratio of 85 mass % or more and 95 mass % or less, and the water are mixed.

7. A method of producing a cleaned object in which a cleaning target is cleaned, comprising:
preparing the cleaning target;
preparing a cleaning agent containing an alkaline aqueous solution and glass particles;
cleaning the cleaning target by spraying the cleaning agent onto the cleaning target; and
obtaining the cleaned object as the cleaning target after cleaning.

8. The method of producing the cleaned object according to claim 7, further comprising:
in the preparing of the cleaning agent,
preparing baking soda particles with an average particle diameter of 200 μm or more and 400 μm or less, the glass particles with an average particle diameter of 200 μm or more and 400 μm or less, and water; and
mixing the baking soda particles, the glass particles, and the water, wherein,
in the mixing, a volume ratio of solids before mixing to a total volume which is a sum of a volume of solids before mixing containing the baking soda particles and the glass particles and a volume of the water, is 10 vol % or more and 30 vol % or less, and a mass ratio of the glass particles in the solids before mixing is greater than 50 mass % and equal to or less than 99 mass %.

9. The method of producing the cleaned object according to claim 7, further comprising:
measuring the lightness of a surface of the cleaned object after obtaining the cleaned object; and
when the measured lightness is equal to or greater than a second predetermined threshold, determining that the cleaned object is deemed a satisfactory product.

10. A method of cleaning a cleaning target on which dirt has adhered, comprising:
preparing the cleaning target;
preparing a cleaning agent containing an alkaline aqueous solution and glass particles; and
cleaning the cleaning target by spraying the cleaning agent onto the cleaning target, to remove the dirt from the cleaning target.

11. The method of cleaning the cleaning target according to claim 10, further comprising:
measuring the lightness of a surface of the cleaning target before cleaning; and
when the measured lightness is equal to or greater than a first predetermined threshold, determining that it is possible for the cleaning to remove dirt from the cleaning target.
